(19) United States
(12) Patent Application Publication
(10) Pub. No.: US 2020/0284666 A1
(43) Pub. Date: Sep. 10, 2020

(54) TRANSDUCER SHEET

(71) Applicant: Sumitomo Riko Company Limited, Aichi (JP)

(72) Inventors: Wataru TAKAHASHI, Aichi (JP); Shingo HIBINO, Aichi (JP)

(73) Assignee: Sumitomo Riko Company Limited, Aichi (JP)

(21) Appl. No.: 16/884,036

(22) Filed: May 26, 2020

Related U.S. Application Data
(63) Continuation of application No. PCT/JP2019/004098, filed on Feb. 5, 2019.

(30) Foreign Application Priority Data
Mar. 26, 2018 (JP) 2018-058135

(51) Int. Cl. G01L 1/16; G01L 1/14

(52) U.S. Cl. CPC G01L 1/16; G01L 1/14

(57) ABSTRACT

A transducer sheet is provided, including a transducer sheet body for converting an input energy into a different output energy; and connecting connectors provided at connecting parts of the transducer sheet body and being able to physically and electrically connect plural transducer sheet bodies in plural directions at the connecting part.

### CROSS-REFERENCE TO RELATED APPLICATION

The present application is a continuation of PCT/JP2019/004098, filed on Feb. 5, 2019, and is related to and claims priority from Japanese patent application no. 2018-058135, filed on Mar. 26, 2018. The entire contents of the aforementioned application are hereby incorporated by reference herein.

### FIELD OF INVENTION

The present disclosure relates to a transducer sheet which converts input energy into output energy which is different from the input energy.

### RELATED ART

Conventionally, for example, a transducer sheet which constitutes a pressure sensor for converting a working pressure into a voltage and detecting the pressure, an actuator for outputting a force according to an applied voltage, and the like have been proposed. As the transducer sheet, for example, there is a sensor sheet which constitutes a pressure distribution sensor disclosed in Japanese Patent Application Laid-Open No. 2006-284404 (Patent Literature 1), and the like, and a detection voltage which is output energy changes in accordance with a working pressure which is input energy.

Incidentally, a plurality of sensor sheets of Patent Literature 1 may be connected in series, and thus it is possible to change an area of a pressure detection region in the pressure distribution sensor without increasing a size of each of the sensor sheets.

However, in the structure described in Patent Literature 1, a plurality of sensor sheets is connected at an interconnection connector in a right and left direction, and it is possible to increase a size of a pressure detection region in the right and left direction but not in a vertical direction. In short, Patent Literature 1 merely discloses a structure in which the plurality of sensor sheets can be linearly arranged and connected in a specific direction.

Further, Japanese Patent No. 5414682 (Patent Literature 2) proposes a configuration of a tactile sensor applicable to a surface of a robot in which a plurality of tactile sensor modules is connected to each other. In the tactile sensor module of Patent Literature 2, one of an input connection port and an output connection port is disposed on each of three sides of a triangular flat substrate, and it is possible to configure the tactile sensor with a surface shape having a greater degree of freedom by connecting the input connection port and the output connection port of the adjacent tactile sensor modules to each other.

However, in the tactile sensor module of Patent Literature 2, both the input connection port and the output connection port can be connected only in a direction orthogonal to a side portion of the flat substrate, and the adjacent tactile sensor modules cannot be connected except in the direction orthogonal to the side portion of the flat substrate. As described above, the tactile sensor module of Patent Literature 2 has a problem that the direction in which connection is possible is limited by the shape of the flat substrate.

### SUMMARY

The present disclosure has been made in view of the above circumstances, and provides a transducer sheet and a plurality of transducer sheets is able to be connected to each other with a greater degree of freedom.

Hereinafter, aspects of the present disclosure will be described. The constituent elements used in each of the following aspects can be used in any feasible combination.

That is, a first aspect of the present disclosure is a transducer sheet including (i) a transducer sheet body that converts an input energy into an output energy which is different from the input energy, and (ii) a connecting connector provided at a connecting part of the transducer sheet body and being able to physically and electrically connect a plurality of transducer sheet bodies each other in a plurality of directions at the connecting part.

### BRIEF DESCRIPTION OF DRAWINGS

FIG. 1 is a plan view showing a pressure sensor sheet as a first embodiment of the present disclosure.

FIG. 2 is a cross-sectional view along line II-II of FIG. 1.

FIG. 3 is an enlarged view showing a part of a sensor sheet body which constitutes the pressure sensor sheet shown in FIG. 2.

FIG. 4 is an enlarged view showing a right end portion of FIG. 1.

FIG. 5 is a cross-sectional view along line V-V of FIG. 4.

FIG. 6 is a cross-sectional view along line VI-VI of FIG. 5.

FIG. 7 is a plan view showing one connection mode of the pressure sensor sheet shown in FIG. 1.

FIG. 8 is a plan view showing another connection mode of the pressure sensor sheet shown in FIG. 1.

FIG. 9 is a plan view showing yet another connection mode of the pressure sensor sheet shown in FIG. 1.

FIG. 10 is a plan view showing still another connection mode of the pressure sensor sheet shown in FIG. 1.

FIG. 11 is a partial plan view showing a connection mode of a pressure sensor sheet as another embodiment of the present disclosure.

### DESCRIPTION OF EMBODIMENTS

Hereinafter, embodiments of the present disclosure will be described with reference to the drawings.

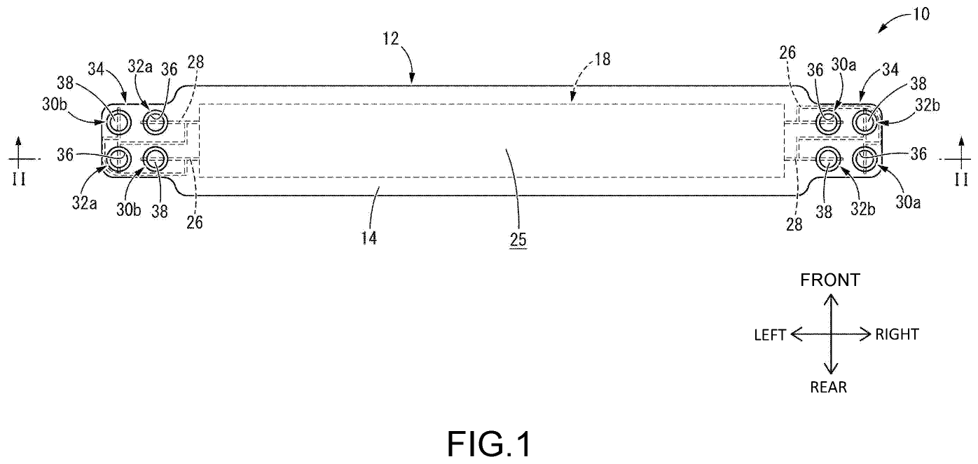

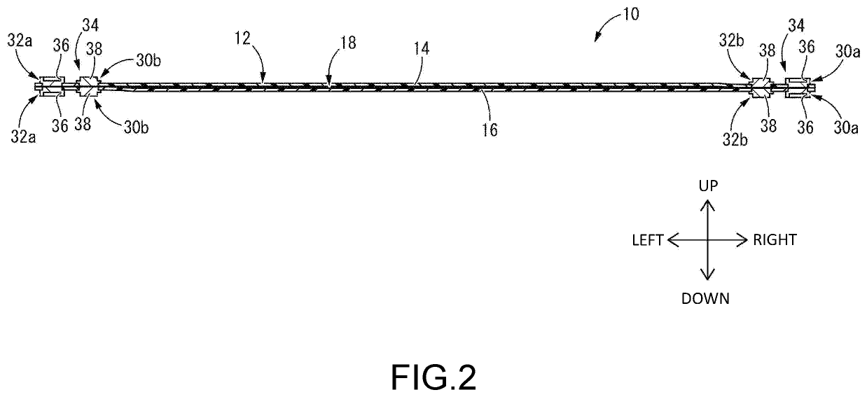

FIGS. 1 and 2 show a pressure sensor sheet 10 as a first embodiment of a transducer sheet having a structure according to the present disclosure. The pressure sensor sheet 10 includes a sensor sheet body 12 as a transducer sheet body. In the following description, as a general rule, as indicated by arrows in FIGS. 1 and 2, a vertical direction is a vertical direction in FIG. 2, forward and rearward directions are vertical directions in FIG. 1, and right and left directions are right and left directions in FIG. 1.

More specifically, the sensor sheet body 12 has a thin strip shape as a whole and has a structure in which a piezoelectric element 18 is disposed between a first protective layer 14 and a second protective layer 16. Additionally, mechanical input energy (pressure) which acts in a thickness direction on a pressure detection region 25 of the sensor sheet body 12 that will be described later is converted into electrical output energy (piezoelectricity) by the piezoelectric element 18.

The first protective layer 14 and the second protective layer 16 are formed of an electrically insulating material such as a synthetic resin elastomer or rubber and have a thin strip shape which extends in right and left directions as a whole, and forward and rearward width dimensions of left and right end portions which form connecting parts 34 and 34 that will be described later are smaller than intermediate portions in the right and left directions. Additionally, the first protective layer 14 and the second protective layer 16 are superimposed on each other in the vertical direction, outer peripheral portions thereof are fixed to each other to form substantially a bag shape having a space inside, and the piezoelectric element 18 is disposed between the first protective layer 14 and the second protective layer 16. A fixing means between the outer peripheral portions of the first protective layer 14 and the second protective layer 16 is not particularly limited, but, for example, adhesion or welding, fixing by sewing, detachable fixing by a hook-and-loop fastener, or the like can be adopted.

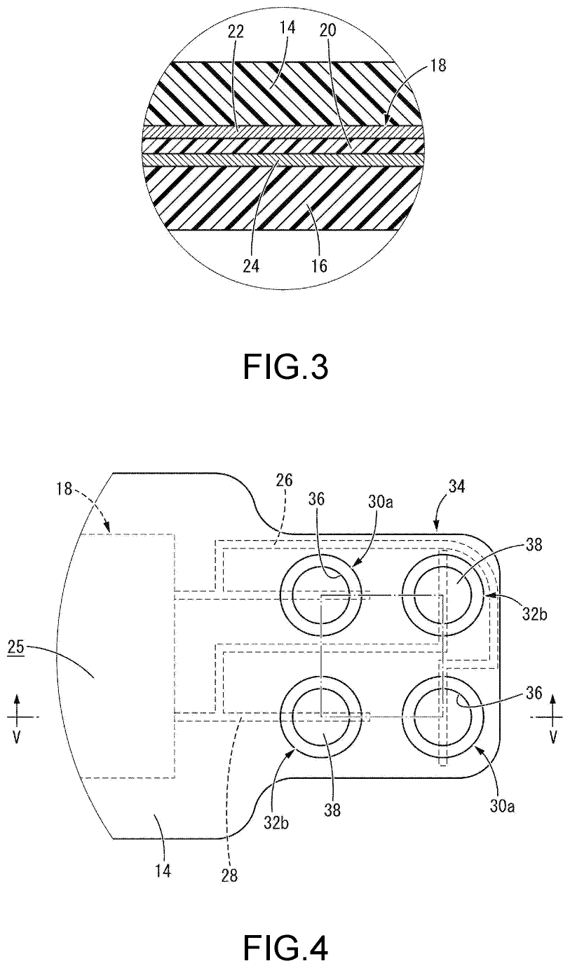

The piezoelectric element 18 has a rectangular strip shape as a whole and has a structure in which one side of each of a first electrode layer 22 and a second electrode layer 24 are superimposed as electrodes on upper and lower surfaces of the piezoelectric layer 20, as shown in FIG. 3.

As shown in FIGS. 1 to 3, the piezoelectric layer 20 has a rectangular band shape and is formed of a piezoelectric material to generate piezoelectricity (voltage) having a magnitude corresponding to a load (a pressure) input in a thickness direction. The material for forming the piezoelectric layer 20 preferably has a piezoelectric property, and may also have flexibility and elasticity, and for example, a material in which a flexible crosslinked rubber having a relatively small elastic modulus and a thermoplastic elastomer are mixed with piezoelectric particles which are particles of a compound having a piezoelectric property is used.

Specifically, for example, urethane rubber, silicone rubber, nitrile rubber, hydrogenated nitrile rubber, acrylic rubber, natural rubber, isoprene rubber, ethylene-propylene-diene rubber, an ethylene-vinyl acetate copolymer, an ethylene-vinyl acetate-acrylic acid ester copolymer, butyl rubber, styrene-butadiene rubber, fluororubber, epichlorohydrin rubber, chloroprene rubber, chlorinated polyethylene, chlorosulfonated polyethylene, thermoplastic polyurethane, and the like are preferably used as the elastomer.

Further, examples of the compound having a piezoelectric property include barium titanate, strontium titanate, potassium niobate, sodium niobate, lithium niobate, potassium sodium niobate, potassium sodium niobate lithium, lead zirconate titanate, strontium barium titanate, bismuth lanthanum titanate, bismuth strontium tantalite, and the like. The piezoelectric particles may be composed of only one the above-described compounds or may be composed of a plurality thereof. Furthermore, from the viewpoint of making the piezoelectric layer 20 thin, an average particle diameter of the piezoelectric particles is preferably 10 μm or less.

The first electrode layer 22 and the second electrode layer 24 are thin film conductors and may be formed of a metal. However, the first electrode layer 22 and the second electrode layer 24 may be formed of conductive ink or silver paste in which a polymer elastomer such as a synthetic resin or rubber is mixed with conductive fillers such as metal particles, metal oxide particles, metal carbide particles, metal nanowires, carbon black, carbon nanotubes, graphite, graphene, and the like and thus may have flexibility and elasticity which follow the piezoelectric layer 20. More preferably, for example, metal nanowires, carbon nanotubes, thin-layer graphite, and graphene may be adopted as the filler having a large aspect ratio which can achieve high flexibility and elasticity. Further, as shown in FIG. 3, the first and second electrode layers 22 and 24 are electrically connected to the piezoelectric layer 20 by being superimposed on the surfaces of the piezoelectric layer 20 in a contact state. Then, when a pressure is applied to the piezoelectric layer 20, a potential difference according to the applied pressure is generated between the first and second electrode layers 22 and 24.

For example, a piezoelectric layer and an electrode layer described in Japanese Patent No. 6034543 are preferably applied as the piezoelectric layer 20 and the first and second electrode layers 22 and 24 which configure a piezoelectric element 18.

The piezoelectric element 18 having such a structure is disposed between the first protective layer 14 and the second protective layer 16. Additionally, a vertical projection region of the piezoelectric element 18 indicated by broken lines in FIG. 1 is a pressure detection region 25 that is an energy conversion region in the pressure sensor sheet 10. The piezoelectric element 18 may be formed separately from the first and second protective layers 14 and 16, may be disposed in an accommodated state between the bag-shaped first and second protective layers 14 and 16 and may also be formed integrally with the first and second protective layers 14 and 16. Specifically, for example, the first electrode layer 22 may be formed on a lower surface of the first protective layer 14 by printing and the second electrode layer 24 may be formed on an upper surface of the second protective layer 16 by printing, the first electrode layer 22 provided on the first protective layer 14 and the second electrode layer 24 provided on the second protective layer 16 may be superimposed from the upper and lower sides of the piezoelectric layer 20, and thus the piezoelectric element 18 may be integrally formed with the first and second protective layers 14 and 16 while being disposed between the first protective layer 14 and the second protective layer 16.

Further, a first wiring 26 and a second wiring 28 are connected to the piezoelectric element 18. The first and second wirings 26 and 28 are formed of a conductive material similarly to the first and second electrode layers 22 and 24, the first wiring 26 is connected to the first electrode layer 22 and extends to the right and left outer connecting parts 34 and 34 (described later), and the second wiring 28 is connected to the second electrode layer 24 and extends to the right and left outer connecting parts 34 and 34. Although the first and second wirings 26 and 28 are provided in the connecting parts 34 and 34 in a plane in the embodiment, for example, the first and second wirings 26 and 28 may be formed in multiple layers with an insulating layer interposed therebetween, and the first and second wirings 26 and 28 may be provided in a mutually insulated state even for the connecting parts 34 and 34 having a small projection area in the vertical direction by adopting such three-dimensional wiring.

Although the first wiring 26 may be integrally formed with the first electrode layer 22, for example, it is possible to secure conductivity of the first wiring 26 having a small cross-sectional area while reducing cost of the first electrode layer 22 having a large cross-sectional area by forming the first electrode layer 22 with a conductive ink containing carbon black as a conductive filler and forming the first wiring 26 with a silver paste. Further, similarly, the second wiring 28 and the second electrode layer 24 may be formed of the same material or may be formed of different materials.

Further, as shown in FIG. 4, the first wiring 26 is connected to a first connecting connector 30 as a connecting connector, and the second wiring 28 is connected to a second connecting connector 32 as a connecting connector. The first and second connecting connectors 30 and 32 are formed of a conductive material such as a metal or a conductive resin, have substantially a thick circular disk shape and are disposed in the connecting parts 34 and 34 provided at both right and left end portions constituting the outer peripheral portion of the sensor sheet body 12. Additionally, the first connecting connector 30 is connected to the first electrode layer 22 by the first wiring 26, the second connecting connector 32 is connected to the second electrode layer 24 by the second wiring 28, and the first connecting connector 30 and the second connecting connector 32 respectively constitute a positive electrode and a negative electrode. The first and second connecting connectors 30 and 32 are provided on both upper and lower surfaces of the sensor sheet body 12, and a plurality of first and second connecting connectors 30 and 32 is respectively disposed at both right and left end portions of the first protective layer 14 and both right and left end portions of the second protective layer 16, which constitute the connecting parts 34 and 34, to vertically pass therethrough and is fixed to one of the first and second protective layer 14 and 16.

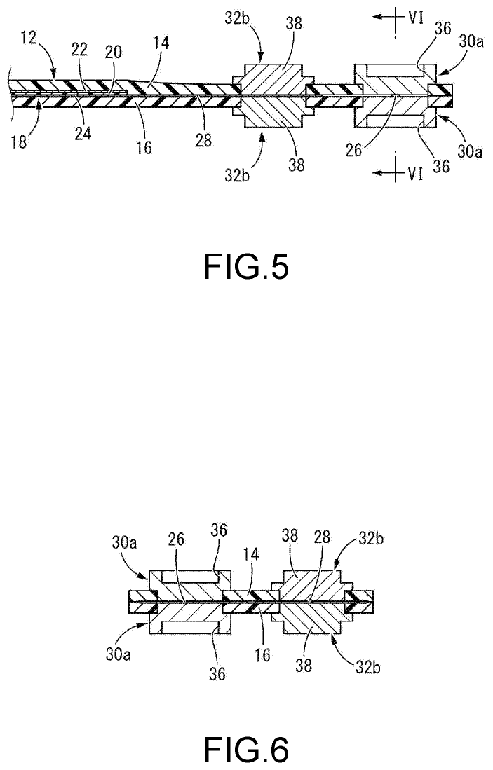

Further, as shown in FIG. 2, the plurality of first connecting connectors 30 includes a first connecting connector 30a (refer to FIGS. 5 and 6) having a concave cross section having a concave portion 36 which open vertically and outward in an inner peripheral portion, and a first connecting connector 30b having a convex cross section having a convex portion 38 which protrudes vertically and outward on the inner peripheral portion. In the embodiment, two first connecting connectors 30a are disposed on both upper and lower surfaces of the right connecting part 34, and two first connecting connectors 30b are disposed on both upper and lower surfaces of the left connecting part 34. Then, the first connecting connector 30a and the first connecting connector 30b are physically and electrically connected by fitting the convex portion 38 of the first connecting connector 30b into the concave portion 36 of the first connecting connector 30a.

Further, the plurality of second connecting connectors 32 includes a second connecting connector 32a having a concave cross section having a concave portion 36 which opens vertically and outward in an inner peripheral portion, and a second connecting connectors 32b (referring to FIGS. 5 and 6) having a convex cross section having a convex portion 38 which protrudes vertically and outward on the inner peripheral portion. In the embodiment, two second connecting connectors 32b are disposed on both upper and lower surfaces of the right connecting part 34, and two second connecting connectors 32a are disposed on both upper and lower surfaces of the left connecting part 34. Then, the second connecting connector 32a and the second connecting connector 32b are physically and electrically connected by fitting the convex portion 38 of the second connecting connector 32b into the concave portion 36 of the second connecting connector 32a.

The first connecting connectors 30a and 30b and the second connecting connectors 32a and 32b of the embodiment may be structured like spring hooks, and the convex portions 38 are fitted into the concave portions 36 in a detachable manner. Thus, connection of the pressure sensor sheet 10 can be redone by the first and second connecting connectors 30 and 32, and a connection mode such as a connection direction and the number of connections can be changed as necessary. The convex portions and the concave portions having different shapes may be provided on the first connecting connector 30 and the second connecting connector 32 to prevent the convex portion or concave portion of the first connecting connector 30 from being fitted into the concave portion or the convex portion of the second connecting connector 32, and thus the first connecting connector 30 and the second connecting connector 32 may be prevented from being accidentally connected.

Further, in the right connecting part 34, the two first connecting connectors 30a and 30a and the two second connecting connectors 32b and 32b fixed to the first protective layer 14 are located at four corners of a square (one-dot chain line in FIG. 4) as one aspect of a rhombus which is a quadrangle of which four sides have equal lengths, the two first connecting connectors 30a and 30a are disposed to face each other in one diagonal direction, and the two second connecting connectors 32b and 32b are disposed to face each other in the other diagonal direction. In the embodiment, the first connecting connectors 30a are disposed at the upper left and lower right corners of the square, and the second connecting connectors 32b are disposed at the lower left and upper right corners of the square.

Accordingly, both the two first connecting connectors 30a and 30a which face each other in one diagonal direction of the square are connected to the first electrode layer 22 and have the same polarity, and both the two second connecting connectors 32b and 32b which face each other in the other diagonal direction of the square are connected to the second electrode layer 24 and have the same polarity. Furthermore, the first connecting connector 30a and the second connecting connector 32b are disposed alternately in a circumferential direction of the square, and the two connecting connectors adjacent to each other in the circumferential direction of the square are respectively connected to the first and second electrode layers 22 and 24 and have different polarities.

In the right connecting part 34, the two first connecting connectors 30a and 30a and the two second connecting connectors 32b and 32b fixed to the second protective layer 16 are also disposed in the same manner in a top view. Additionally, as shown in FIGS. 5 and 6, in the right connecting part 34, the first connecting connectors 30a and 30a fixed to the first protective layer 14 and the first connecting connectors 30a and 30a fixed to the second protective layer 16 are vertically disposed at positions corresponding to each other, and the second connecting connectors 32b and 32b fixed to the first protective layer 14 and the second connecting connectors 32b and 32b fixed to the second protective layer 16 are disposed vertically at positions corresponding to each other.

Further, in the left connecting part 34, the two first connecting connectors 30b and 30b and the two second connecting connectors 32a and 32a fixed to the first protective layer 14 are located at corners of a virtual square (not shown), the two first connecting connectors 30b and 30b are disposed to face each other in one diagonal direction, and the two second connecting connectors 32a and 32a are disposed to face each other in the other diagonal direction. In the embodiment, the first connecting connectors 30b are disposed at the upper left and lower right corners of the square, and the second connecting connectors 32a are disposed at the lower left and upper right corners of the square.

Accordingly, both the two first connecting connectors 30b and 30b which face each other in one diagonal direction of the square are connected to the first electrode layer 22 and have the same polarity, and both the two second connecting connectors 32a and 32a which face each other in the other diagonal direction of the square are connected to the second electrode layer 24 and have the same polarity. Furthermore, the first connecting connector 30b and the second connecting connector 32a are disposed alternately in a circumferential direction of the square, and the two connecting connectors adjacent to each other in the circumferential direction of the square are respectively connected to the first and second electrode layers 22 and 24 and have different polarities.

In the left connecting part 34, the two first connecting connectors 30b and 30b and the two second connecting connectors 32a and 32a fixed to the second protective layer 16 are also disposed in the same manner in a top view. Additionally, in the left connecting part 34, the first connecting connectors 30b and 30b fixed to the first protective layer 14 and the first connecting connectors 30b and 30b fixed to the second protective layer 16 are vertically disposed at positions corresponding to each other, and the second connecting connectors 32a and 32a fixed to the first protective layer 14 and the second connecting connectors 32a and 32a fixed to the second protective layer 16 are disposed vertically at positions corresponding to each other.

Further, the four first connecting connectors 30a, 30a, 30a, and 30a provided at the right connecting part 34 are connected to one first wiring 26. The first connecting connectors 30a and 30a disposed vertically at positions corresponding to each other are connected to the same first wiring 26 by disposing the first wiring 26 in the contact state between the upper and lower sides thereof. Thus, the four first connecting connectors 30a, 30a, 30a, and 30a provided at the right connecting part 34 are all connected to the first electrode layer 22 via the first wiring 26.

Further, the four first connecting connectors 30b, 30b, 30b, and 30b provided at the left connecting part 34 are similarly connected to the other one first wiring 26.

Further, the four second connecting connectors 32b, 32b, 32b, and 32b provided at the right connecting part 34 are connected to one second wiring 28. The second connecting connectors 32b and 32b disposed vertically at the positions corresponding to each other are connected to the same second wiring 28 by disposing the second wiring 28 in the contact state between the upper and lower sides thereof. Thus, the four second connecting connectors 32b, 32b, 32b, and 32b provided at the right connecting part 34 are all connected to the second electrode layer 24 via the second wiring 28.

Further, the four second connecting connectors 32a, 32a, 32a, and 32a provided at the left connecting part 34 are similarly connected to the other one second wiring 28.

In this way, the plurality of first connecting connectors 30 connected to the first electrode layer 22 and the plurality of second connecting connectors 32 connected to the second electrode layer 24 are provided in the connecting parts 34 and 34 provided at both the right and left end portions of the sensor sheet body 12 to be exposed from the electrically insulating first and second protective layers 14 and 16.

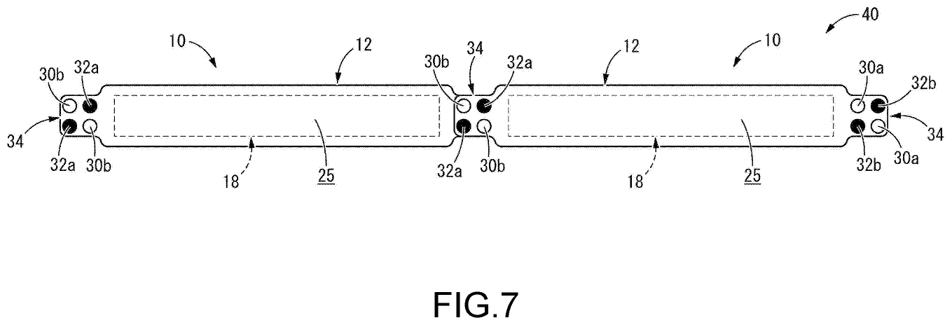

The pressure sensor sheet 10 having such a structure can be physically and electrically connected to other pressure sensor sheets 10 in a plurality of directions in the connecting parts 34 and 34 provided at the right and left end portions. Hereinafter, the connection modes of the plurality of pressure sensor sheets 10 shown in FIGS. 7 to 10 will be described. In FIGS. 7 to 10, the first connecting connector 30 is shown by a white circle, and the second connecting connector 32 is shown by a black circle for the sake of clarity.

FIG. 7 shows a pressure sensor 40 as a transducer. The pressure sensor 40 has a structure in which two pressure sensor sheets 10 and 10 are arranged and connected in a straight line in a right and left direction. More specifically, in FIG. 7, the connecting part 34 at the left end of the right pressure sensor sheet 10 is superimposed on the connecting part 34 at the right end of the left pressure sensor sheet 10 from above.

Additionally, each of the convex portions 38 of the first connecting connectors 30b and 30b provided in the connecting part 34 at the left end of the right pressure sensor sheet 10 is fitted into each of the concave portions 36 of the first connecting connectors 30a and 30a provided in the connecting part 34 at the right end of the left pressure sensor sheet 10, and thus the first connecting connectors 30a and 30a and the first connecting connectors 30b and 30b are physically connected to each other. Further, each of the convex portions 38 of the second connecting connectors 32b and 32b provided in the connecting part 34 at the right end of the left pressure sensor sheet 10 is fitted into each of the concave portions 36 of the second connecting connectors 32a and 32a provided in the connecting part 34 at the left end of the right pressure sensor sheet 10, and thus the second connecting connectors 32b and 32b and the second connecting connectors 32a and 32a are physically connected to each other.

Here, since both the first connecting connector 30a and the first connecting connector 30b are conductors, the first connecting connector 30a and the first connecting connector 30b are physically and electrically connected at the same time by the concave-convex fitting. Thus, the first electrode layer 22 of the left pressure sensor sheet 10 and the first electrode layer 22 of the right pressure sensor sheet 10 are electrically connected by the connection between the first connecting connector 30a and the first connecting connector 30b and serve as a substantially integrated electrode.

Furthermore, since both the second connecting connector 32a and the second connecting connector 32b are conductors, the second connecting connector 32a and the second connecting connector 32b are physically and electrically connected at the same time by the concave-convex fitting. Thus, the second electrode layer 24 of the left pressure sensor sheet 10 and the second electrode layer 24 of the right pressure sensor sheet 10 are electrically connected by the connection between the second connecting connector 32a and the second connecting connector 32b and serve as a substantially integrated electrode.

Therefore, the pressure detection region 25 of the left pressure sensor sheet 10 and the pressure detection region 25 of the right pressure sensor sheet 10 function integrally by arranging and connecting the two pressure sensor sheets 10 and 10 right and left, and thus the pressure sensor 40 having a wider pressure detection region in the right and left direction can be configured by the two pressure sensor sheets 10 and 10.

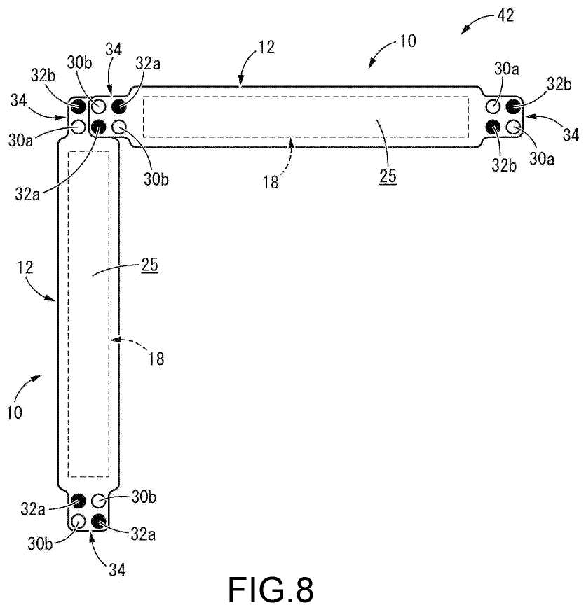

FIG. 8 shows a pressure sensor 42 as a transducer. The pressure sensor 42 has a structure in which two pressure sensor sheets 10 and 10 are connected to each other while being disposed in a hooked state so that their length directions are orthogonal to each other.

More specifically, in FIG. 8, one pressure sensor sheet 10 (the rear pressure sensor sheet 10) is disposed to be long in the forward and rearward direction, the other pressure sensor sheet 10 (the right pressure sensor sheet 10) is disposed to be long in the right and left direction, and the pressure sensor sheets 10 and 10 are disposed on substantially the same plane in directions substantially orthogonal to each other. The rear pressure sensor sheet 10 is rotated right by 90° with respect to the right pressure sensor sheet 10 to be long in the forward and rearward direction.

Further, the connecting part 34 at the left end of the right pressure sensor sheet 10 is superimposed on the connecting part 34 at the front end of the rear pressure sensor sheet 10 from above. In the embodiment, the left half of the connecting part 34 at the left end of the right pressure sensor sheet 10 is superimposed on the right half of the connecting part 34 at the front end of the rear pressure sensor sheet 10.

Then, the convex portion 38 of the first connecting connector 30b provided in the connecting part 34 at the left end of the right pressure sensor sheet 10 is fitted into the concave portion 36 of the first connecting connector 30a provided in the connecting part 34 at the front end of the rear pressure sensor sheet 10, and the first connecting connector 30a and the first connecting connector 30b are physically and electrically connected. Furthermore, the convex portion 38 of the second connecting connector 32b provided in the connecting part 34 at the front end of the rear pressure sensor sheet 10 is fitted into the concave portion 36 of the second connecting connector 32a provided in the connecting part 34 at the left end of the right pressure sensor sheet 10, and the second connecting connector 32b and the second connecting connector 32a are physically and electrically connected.

Thus, the first electrode layer 22 of the rear pressure sensor sheet 10 and the first electrode layer 22 of the right pressure sensor sheet 10 are electrically connected by the connection between the first connecting connector 30a and the first connecting connector 30b and serve as a substantially integrated electrode. Further, the second electrode layer 24 of the rear pressure sensor sheet 10 and the second electrode layer 24 of the right pressure sensor sheet 10 are electrically connected by the connection between the second connecting connector 32a and the second connecting connector 32b and serve as a substantially integrated electrode.

Therefore, the pressure detection region 25 of the rear pressure sensor sheet 10 and the pressure detection region 25 of the right pressure sensor sheet 10 integrally function by arranging and connecting the two pressure sensor sheets 10 and 10 on the substantially same plane to be substantially orthogonal to each other, and thus it is possible to configure the pressure sensor 42 having a pressure detection region which spreads like a hook.

As can be seen from FIGS. 7 and 8, when the two pressure sensor sheets 10 and 10 are connected, it is possible to connect one pressure sensor sheet 10 to the other pressure sensor sheet 10 in a plurality of directions which are different from each other in a plan view. Specifically, in the embodiment, one pressure sensor sheet 10 can be selectively connected to the other pressure sensor sheet 10 at any angle of 90°, 180°, and 270°.

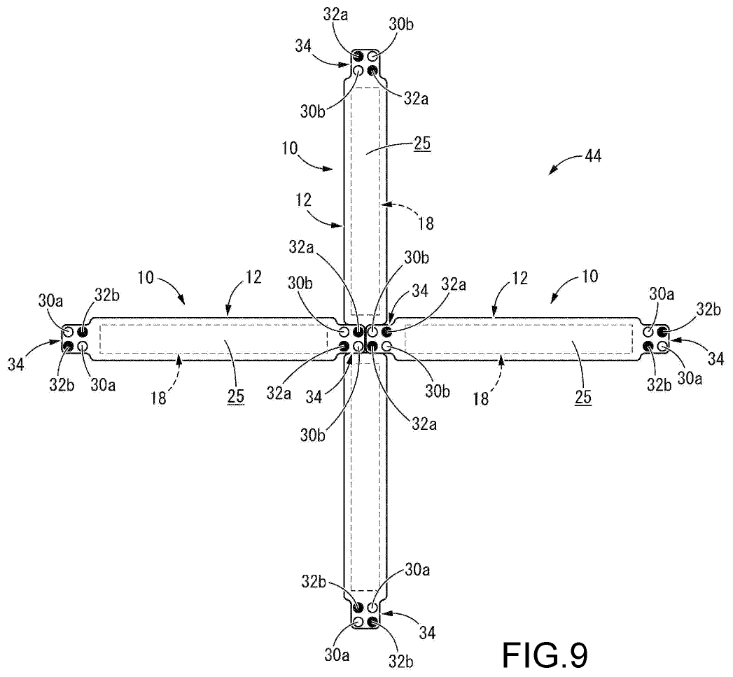

FIG. 9 shows a pressure sensor 44 as a transducer. The pressure sensor 44 has a structure in which two pressure sensor sheets 10 and 10 extending in the right and left direction and two pressure sensor sheets 10 and 10 extending in the forward and rearward direction are arranged and connected in a cross shape. That is, in FIG. 9, fourth pressure sensor sheets 10, 10, 10, and 10 are connected in a cross shape by combining a linear connection mode of the plurality of pressure sensor sheets 10 shown in FIG. 7 and a hook-shaped connection mode in which the plurality of pressure sensor sheets 10 shown in FIG. 8 are bent by 90°.

More specifically, in FIG. 9, the connecting part 34 at the rear end of the front pressure sensor sheet 10 and the connecting part 34 at the front end of the rear pressure sensor sheet 10 are vertically superimposed and connected to each other. Furthermore, the connecting part 34 at the right end of the left pressure sensor sheet 10 is superimposed from above and connected to the left halves of the connecting parts 34 and 34 of the front and rear pressure sensor sheets 10 and 10 connected to each other, and the connecting part 34 at the left end of the right pressure sensor sheet 10 is superimposed from above and connected to the right halves of the connecting parts 34 and 34 of the front and rear pressure sensor sheets 10 and 10 connected to each other,

Accordingly, the four pressure sensor sheets 10, 10, 10, and 10 are configured so that the first electrode layers 22, 22, 22, and 22 are physically and electrically connected to each other and serve as an integral electrode layer and the second electrode layers 24, 24, 24, and 24 are physically and electrically connected to each other and serve as an integral electrode layer. Therefore, the pressure detection regions 25 of the four pressure sensor sheets 10, 10, 10, and 10 integrally function to form the pressure sensor 44 having a pressure detection region which spreads in a cross shape.

Although FIG. 9 shows an example in which the four pressure sensor sheets 10, 10, 10, and 10 are connected in a cross shape, for example, it is possible to connect a plurality of pressure sensor sheets 10 in a grid pattern other than the cross shape by a combination of the linear connection of the plurality of pressure sensor sheets 10 shown in FIG. 7 and the hook-shaped connection in which the plurality of pressure sensor sheets 10 shown in FIG. 8 are bent by 90°.

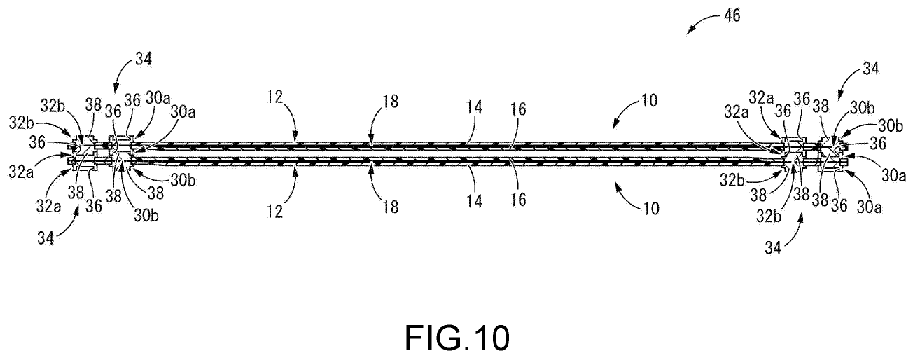

FIG. 10 shows a pressure sensor 46 as a transducer. The pressure sensor 46 has a structure in which the two pressure sensor sheets 10 and 10 are superimposed in the vertical direction which is the thickness direction and are physically and electrically connected in a three-dimensionally stacked state.

More specifically, in FIG. 10, an upper pressure sensor sheet 10 is disposed in a state of being rotated by 180° about a rotation axis extending in the vertical direction with respect to a lower pressure sensor sheet 10. Thus, in the upper pressure sensor sheet 10, the first connecting connectors 30a and 30a and the second connecting connectors 32b and 32b are provided in the connecting part 34 at the left end, and the first connecting connectors 30b and 30b and the second connecting connectors 32a and 32a are provided in the connecting part 34 at the right end.

Additionally, the first connecting connectors 30b and 30b and the second connecting connectors 32a and 32a provided on the lower surface of the connecting part 34 at the right end of the upper pressure sensor sheet 10 are connected to the first connecting connectors 30a and 30a and the second connecting connectors 32b and 32b provided on the upper surface of the connecting part 34 at the right end of the lower pressure sensor sheet 10 by the concave-convex fitting. Further, the first connecting connectors 30a and 30a and the second connecting connectors 32b and 32b provided on the lower surface of the connecting part 34 at the left end of the upper pressure sensor sheet 10 are connected to the first connecting connectors 30b and 30b and the second connecting connectors 32a and 32a provided on the upper surface of the connecting part 34 at the left end of the lower pressure sensor sheet 10 by the concave-convex fitting.

Accordingly, the first electrode layer 22 of the upper pressure sensor sheet 10 and the first electrode layer 22 of the lower pressure sensor sheet 10 are electrically connected by the connection between the first connecting connector 30a and the first connecting connector 30b, and the second electrode layer 24 of the upper pressure sensor sheet 10 and the second electrode layer 24 of the lower pressure sensor sheet 10 are electrically connected by the connection between the second connecting connector 32a and the second connecting connector 32b.

According to the pressure sensor 46 in which the two pressure sensor sheets 10 and 10 are connected in the stacked state in which they are vertically stacked, since a voltage generated by a piezoelectric action increases with respect to the pressure input in the vertical direction, pressure detection accuracy can be improved.

In FIG. 10, although the structure in which the two pressure sensor sheets 10 and 10 are stacked has been described, it is also possible to superimpose and connect three or more pressure sensor sheets 10 in the stacked state. In this case, the first connecting connector 30a and the first connecting connector 30b can be connected in the vertical direction, and the second connecting connector 32a and the second connecting connector 32b can be connected in the vertical direction by disposing the pressure sensor sheets 10 and 10, which are disposed adjacent to each other in a stacking direction, in a direction in which they are relatively rotated by 180°.

Furthermore, it is also possible to configure a pressure sensor and to connect a plurality of pressure sensor sheets 10 to each other not only in the vertical direction but also in a plurality of directions by further connecting a plurality of the structure bodies 46 shown in FIG. 10 in which a plurality of pressure sensor sheets 10 are connected in a vertically stacked state to each other on a plane orthogonal to the vertical direction as shown in FIGS. 7 to 9. Thus, In the pressure sensor, it is possible to realize improvement of the detection accuracy due to stacking while the pressure detection region is set to be wide. Specifically, since an amount of generated electric charge is doubled by stacking two sensor sheets when the transducer is a piezoelectric type sensor, and a change in capacitance is doubled by stacking two sensor sheets when the transducer is a capacitance type sensor, an SN ratio of the sensor can be easily improved. In addition, it is possible to adjust sensitivity of a sensor configured of the sensor sheet by adjusting the number of stacked sensor sheets, and by connecting the structure body 46 of FIG. 10 in which a plurality of pressure sensor sheets 10 are stacked to a single-layer pressure sensor sheet 10 shown in FIG. 1, the detection accuracy can be partially changed.

In addition, since the piezoelectric layer 20 is a thin film, a volume when stacking is performed can be reduced, and the amount of generated electric charges per unit volume can be increased. When such thin transducer sheets are stacked, and a pressure sensor is configured of the transducer sheets, an amount of displacement when an actuator is configured and an amount of power generation when a generator is configured can be improved, while sensitivity of the sensor per unit volume can be improved.

Therefore, when a set including a plurality of pressure sensor sheets 10 is provided, it is possible to easily obtain a pressure sensor according to the required shape and size of the pressure detection region, the detection sensitivity, or the like by appropriately connecting the plurality of pressure sensor sheets 10.

Although the embodiment of the present disclosure has been described in detail above, the present disclosure is not limited by the specific description thereof. For example, the specific shape of the transducer sheet body is not limited to the strip shape like the sensor sheet body 12 shown in the above-described embodiment, may be a rectangular sheet shape having a square energy conversion region and may be a sheet shape such as a polygonal shape other than a quadrangle, a circular shape, an irregular shape, or the like in accordance with a shape of the necessary energy conversion region or a shape of an installation surface. Further, the transducer sheet bodies connected by the connecting connector may be different from each other in shape and structure.

Further, the connecting part is not necessarily provided at two places on the transducer sheet body and may be provided only at one place or may be provided at three or more places. Also, the connecting part is preferably provided on the outer peripheral portion of the transducer sheet body but may be provided on the inner peripheral portion thereof.

Further, the number and arrangement of the connecting connectors are not limited to the examples of the above-described embodiment. Also, the connection angle (a planar connection direction in the circumferential direction) of the connected transducer sheet may be appropriately set according to the arrangement of the connecting connectors and the like and is not necessarily limited to the three directions of 90°, 180°, and 270° as in the above-described embodiment.

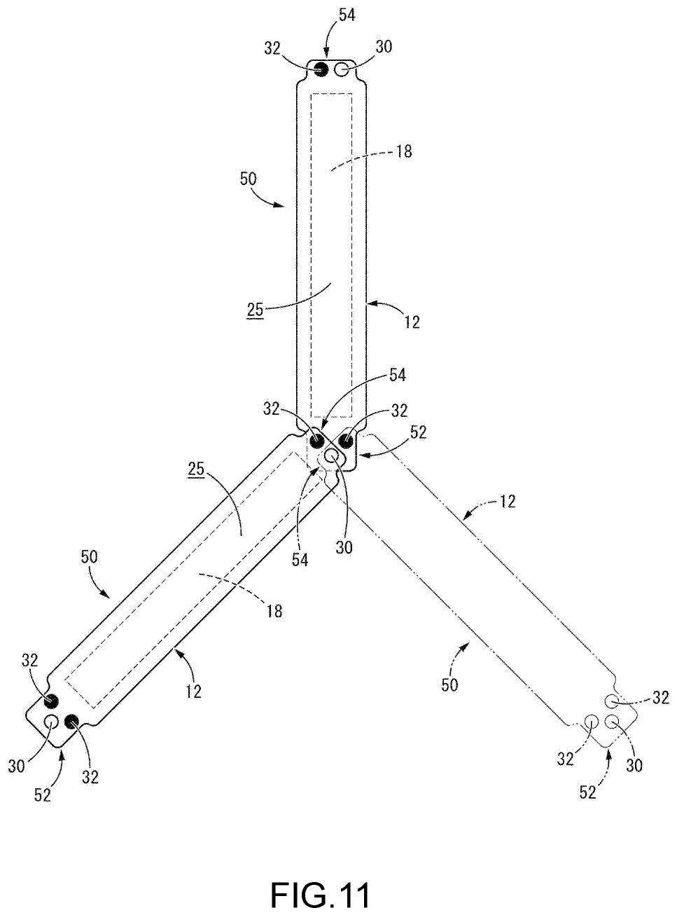

Specifically, for example, a pressure sensor sheet 50 as a transducer sheet as shown in FIG. 11 may be adopted. In the pressure sensor sheet 50, one first connecting connector 30 and two second connecting connectors 32 and 32 disposed to be equidistant from the first connecting connector 30 are provided in one connecting part 52, and one first connecting connector 30 and one second connecting connector 32 are arranged and disposed in the other connecting part 54 in the width direction. Additionally, the pressure sensor sheets 50 and 50 can be connected on substantially the same plane by selectively connecting the second connecting connector 32 provided in the connecting part 54 of the other pressure sensor sheet 50 to one of the two second connecting connectors 32 and 32 provided in the connecting part 52 of one pressure sensor sheet 50.

In FIG. 11, one pressure sensor sheet 50 can be connected to the other pressure sensor sheet 50 at an angle of 135° or 225°. In addition, as shown by the two point chain line in FIG. 11, it is also possible to select another second connecting connector 32 provided in the connecting part 52 of one pressure sensor sheet 50 and to connect the other pressure sensor sheet 50 to one pressure sensor sheet 50 in different directions, and it is also possible to connect an added third pressure sensor sheet 50 to one pressure sensor sheet 50 in a direction different from that of the other pressure sensor sheet 50.

Further, in the above-described embodiment, since a total of four connecting connectors, that is, the two first connecting connectors 30 and 30 and the two second connecting connectors 32 and 32 are disposed in the connecting parts 34 and 34 at both ends of the pressure sensor sheet 10, it is not necessary to invert the front surface and the back surface of the pressure sensor sheet 10 in any connection direction. However, when the front surface and the back surface of the pressure sensor sheet 10 are inverted and connected as needed, the connection in each of the directions can be realized with fewer connecting connectors. Specifically, for example, the connection in each of the directions which can be connected in the above-described embodiment can be realized by providing a total of four connecting connectors including the two first connecting connectors 30 and 30 and the two second connecting connectors 32 and 32 in one connecting part 34 of the pressure sensor sheet 10 and providing a total of two connecting connectors including one first connecting connector 30 and one second connecting connector 32 on the other connecting part 34 of the pressure sensor sheet 10.

Furthermore, the specific structure of the connecting connector is merely an example, and other structures can be adopted as long as physical connection and electrical connection can be realized at the same time. For example, the physical and electrical connection can be detachably realized using a conductive magnet, a spring hook, an adhesive tape, a hook-and-loop fastener, an adhesive, a gluing agent, or the like. When the connecting connector is formed of a conductive adhesive tape, a hook-and-loop fastener, an adhesive, a gluing agent adhesive, or the like, by appropriately adjusting connection positions between the connecting connectors, it is possible to adjust relative positions of the transducer sheets which are mutually connected by the connecting connectors to some extent in a plane direction.

In addition, a C-shaped annular snap ring can be used as the connecting connector. For example, the physical and electrical connection by the connecting connector can be detachably realized by disposing the snap ring as the connecting connector so that an opening on a circumference of the snap ring opens toward an outer periphery at one connecting part of the pressure sensor sheet, providing a shaft fitting protruding in the thickness direction as the connecting connector at the other connecting part of the pressure sensor sheet and then fitting the snap ring of the shaft fitting.

Further, the connecting connector may be allowed to change a position thereof on the transducer sheet body. For example, it is possible to perform the connection in response to component size errors and manufacturing errors, and it is also possible to further improve a degree of freedom in connection in response to a change in a distance between the connecting connectors due to a difference in the connection direction, or the like by providing the connecting connector with a structure capable of sliding displacement with respect to the transducer sheet body and allowing a displacement of the connecting connector in the plane direction of the transducer sheet body. The change in the distance between the connecting connectors in the plane direction and the thickness direction can be allowed by deformation of the transducer sheet body between the plurality of connecting connectors. Also, when one connecting connector to be connected has a structure such as a hook-and-loop fastener in which it spread in a plane, it is possible to allow a substantial change in a position of the connecting connector by appropriately setting the position of the other connecting connector on a surface of the one connecting connector.

Further, in the pressure sensor sheet body 12 of the above-described embodiment, it is also possible to improve the pressure detection accuracy of the pressure sensor sheet 10 by connecting the plurality of piezoelectric elements 18 in the vertically stacked state and disposing the plurality of stacked piezoelectric elements 18 between the first protective layer 14 and the second protective layer 16. Also, the pressure detection accuracy can be further improved by connecting the plurality of pressure sensor sheets 10 including the plurality of piezoelectric elements 18 in the stacked state in the thickness direction.

Further, since the pressure sensor sheet 10 of the above-described embodiment can be connected to another pressure sensor sheet 10 in a plurality of directions and has flexibility and elasticity, the pressure can be detected by mounting it on a complicated deformed surface having a curved surface, unevenness, or the like, or even a surface which is deformed.

Furthermore, in the pressure sensor sheet body 12 of the above-described embodiment, it is also possible to serve as the integrated piezoelectric element 18 by dividing the piezoelectric element 18 into a plurality of parts in the right and left direction and electrically connecting electrode layers of the plurality of divided piezoelectric elements to each other. In other words, in one pressure sensor sheet body 12, the plurality of connected piezoelectric elements can function integrally by arranging the plurality of piezoelectric elements in the right and left direction and connecting them in a mutually conductive state. Accordingly, since a large piezoelectric element is formed by combining small piezoelectric elements, the piezoelectric element can be manufactured more easily than when the large piezoelectric element is integrally formed.

In the above-described embodiment, the piezoelectric pressure sensor sheet 10 which detects a pressure on the basis of a change in voltage due to the piezoelectric action is shown as an example of the transducer sheet. However, the transducer sheet may be, for example, a capacitance type pressure sensor sheet which detects a pressure on the basis of a change in capacitance, a power generation sheet which converts mechanical energy such as the pressure into electric energy and obtains electric power, an actuator sheet which converts electrical energy into mechanical energy and outputs it, or the like.

Other Configurations

That is, a first aspect of the disclosure is a transducer sheet including (i) a transducer sheet body that converts an input energy into an output energy which is different from the input energy, and (ii) a connecting connector provided at a connecting part of the transducer sheet body and being able to physically and electrically connect a plurality of transducer sheet bodies each other in a plurality of directions at the connecting part.

According to the transducer sheet having a structure of the first aspect, since the plurality of transducer sheet bodies is able to be connected to each other in the plurality of directions by the connecting connector, a transducer having a target energy conversion region such as a pressure detection region can be configured by one or more transducer sheets with a large degree of freedom.

Also, since the connecting connector is able to physically connected and electrically connect the plurality of transducer sheet bodies, when compared with a case in which a physical connection structure and an electrical connection structure are separately provided, a structure of the transducer sheet can be simplified, and the plurality of transducer sheets can be easily connected.

In a second aspect of the present disclosure, in the transducer sheet described in the first aspect, the plurality of transducer sheet bodies may be able to be connected in a plane in a plurality of different directions by the connecting connector.

According to the second aspect, the plurality of transducer sheet bodies can be connected to spread in a plane, and a transducer having a wider energy conversion region can be configured.

In a third aspect of the present disclosure, in the transducer sheet described in the first or second aspect, the plurality of transducer sheet bodies may be able to be connected in a thickness direction by the connecting connector.

According to the third aspect, for example, it is possible to obtain a large amount of electricity as output energy with respect to a pressure of input energy, or to obtain a large force as output energy with respect to electricity of input energy by connecting the plurality of transducer sheet bodies by stacking them in the thickness direction. Also, in a sensor which obtains electricity as output energy with respect to a force of input energy, an amount of electricity output is, for example, capacitance when the transducer is a capacitance type sensor, and is an amount of generated electric charge when the transducer is a piezoelectric type sensor.

In a fourth aspect of the present disclosure, in the transducer sheet described in any one of the first to third aspects, the connecting connectors may be provided on both front and back surfaces of the transducer sheet body.

According to the fourth aspect, since the connecting connectors are provided on both the front and back surfaces, it is possible to cause the plurality of transducer sheet bodies to overlap and connect them to the front and back surfaces of the connecting part of one transducer sheet body, for example.

In a fifth aspect of the present disclosure, in the transducer sheet described in any one of the first to fourth aspects, at least one of the connecting parts of the transducer sheet body may have a plurality of the connecting connectors having the same polarity.

According to the fifth aspect, in the connecting part with the plurality of connecting connectors having the same polarity, the transducer sheet bodies can be connected in a plurality of directions with a greater degree of freedom.

In a sixth aspect of the present disclosure, in the transducer sheet described in the fifth aspect, in the at least one connecting part of the transducer sheet body, four of the connecting connectors may be disposed at positions forming four corners of a rhombus, the connecting connectors disposed in a diagonal direction may have the same polarity, and the connecting connectors disposed adjacent to each other in a circumferential direction may have different polarities.

According to the sixth aspect, since it becomes possible to connect the other transducer sheet bodies to the connection portion of one transducer sheet body in a plane in three different directions, the plurality of transducer sheets can be connected with a great degree of freedom. The rhombus of the embodiment is a quadrangle of which all four sides have the same length, and is not limited to a rhombic shape but may be a square.

In a seventh aspect of the present disclosure, in the transducer sheet described in any one of the first to sixth aspects, the connecting connector may be provided on an outer peripheral portion of the transducer sheet body.

According to the seventh embodiment, since connection of the transducer sheet body is performed at the outer peripheral portion, a large energy conversion region such as a pressure detection region can be secured in the inner peripheral portion.

In an eighth aspect of the present disclosure, in the transducer sheet described in any one of the first to seventh aspects, the transducer sheet body may include a piezoelectric element having a structure in which electrodes are superimposed on both surfaces of a piezoelectric layer.

According to the eighth embodiment, a pressure sensor, a generator, an actuator, or the like can be configured by a transducer sheet using a positive effect of piezoelectricity in which a mechanical force of input energy is converted into electricity of output energy, or a negative effect of piezoelectricity in which electricity of input energy is converted into the mechanical force of output energy.

In a ninth aspect of the present disclosure, in the transducer sheet described in any one of the first to eighth aspects, a plurality of the transducer sheet bodies may be able to be connected by the connecting connector in a detachable manner.

According to the ninth embodiment, the connection of the plurality of transducer sheet bodies by the connecting connector can be redone as necessary. Therefore, it is possible to change and set the connection directions of the plurality of transducer sheet bodies as necessary, and it is possible to selectively configure a plurality of types of transducers having different shapes and the like according to the application and the like.

According to the present disclosure, since the plurality of transducer sheet bodies is able to be connected to each other in the plurality of directions by the connecting connector, a transducer having a target energy conversion region such as a pressure detection region can be configured by one or more transducer sheets with a large degree of freedom. Also, since the connecting connector is able to physically and electrically connect the plurality of transducer sheet bodies, when compared with a case in which a physical connection structure and an electrical connection structure are separately provided, a structure of the transducer sheet can be simplified, and the plurality of transducer sheets can be easily connected.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A transducer sheet, comprising:
a transducer sheet body that converts an input energy into an output energy which is different from the input energy; and
a connecting connector provided at a connecting part of the transducer sheet body and being able to physically and electrically connect a plurality of transducer sheet bodies to each other in a plurality of directions at the connecting part.

2. The transducer sheet according to claim 1, wherein the plurality of transducer sheet bodies is able to be connected in a plane in a plurality of different directions by the connecting connector.

3. The transducer sheet according to claim 1, wherein the plurality of the transducer sheet bodies is able to be connected in a thickness direction by the connecting connector.

4. The transducer sheet according to claim 2, wherein the plurality of the transducer sheet bodies is able to be connected in a thickness direction by the connecting connector.

5. The transducer sheet according to claim 1, wherein the connecting connectors are provided on both front and back surfaces of the transducer sheet body.

6. The transducer sheet according to claim 2, wherein the connecting connectors are provided on both front and back surfaces of the transducer sheet body.

7. The transducer sheet according to claim 1, wherein at least one of the connecting parts of the transducer sheet body comprises a plurality of the connecting connectors having the same polarity.

8. The transducer sheet according to claim 2, wherein at least one of the connecting parts of the transducer sheet body comprises a plurality of the connecting connectors having the same polarity.

9. The transducer sheet according to claim 7, wherein, in the at least one connecting part of the transducer sheet body, four of the connecting connectors are disposed at positions forming four corners of a rhombus,
the connecting connectors disposed in a diagonal direction have the same polarity, and
the connecting connectors disposed adjacent to each other in a circumferential direction have different polarities.

10. The transducer sheet according to claim 8, wherein, in the at least one connecting part of the transducer sheet body, four of the connecting connectors are disposed at positions forming four corners of a rhombus,
the connecting connectors disposed in a diagonal direction have the same polarity, and
the connecting connectors disposed adjacent to each other in a circumferential direction have different polarities.

11. The transducer sheet according to claim 1, wherein the connecting connector is provided on an outer peripheral portion of the transducer sheet body.

12. The transducer sheet according to claim 2, wherein the connecting connector is provided on an outer peripheral portion of the transducer sheet body.

13. The transducer sheet according to claim 1, wherein the transducer sheet body comprises a piezoelectric element having a structure in which electrodes are superimposed on both surfaces of a piezoelectric layer.

14. The transducer sheet according to claim 2, wherein the transducer sheet body comprises a piezoelectric element having a structure in which electrodes are superimposed on both surfaces of a piezoelectric layer.

15. The transducer sheet according to claim 1, wherein a plurality of the transducer sheet bodies is able to be connected by the connecting connector in a detachable manner.

16. The transducer sheet according to claim 2, wherein a plurality of the transducer sheet bodies is able to be connected by the connecting connector in a detachable manner.
